(19) United States
(12) Patent Application Publication
(10) Pub. No.: US 2026/0244596 A1
(43) Pub. Date: Aug. 20, 2026

(54) SNAPSHOT STORAGE METHOD AND SYSTEM, DEVICE, AND STORAGE MEDIUM

(71) Applicant: CLOUD INTELLIGENCE ASSETS HOLDING (SINGAPORE) PRIVATE LIMITED, Singapore (SG)

(72) Inventor: Gongjun FEI, Hangzhou (CN)

(21) Appl. No.: 19/161,830

(22) PCT Filed: Feb. 27, 2024
(86) PCT No.: PCT/CN2024/078721

§ 371 Date: Sep. 3, 2025

(30) Foreign Application Priority Data
Mar. 10, 2023 (CN) 202310253795.6

(51) Int. Cl. G06F 16/11; G06F 16/174

(52) U.S. Cl. CPC G06F 16/128; G06F 16/1748

(57) ABSTRACT

Embodiments of the present application provide a snapshot storage method and system, a device, and a storage medium. In response to a full dump request for a target snapshot in a first-type storage resource, the target snapshot may be fully stored into a second-type storage resource, where a storage cost of the second-type storage resource is lower than that of the first-type storage resource. An attribute item used for identifying a storage location of a single data unit is further added to snapshot description information. After the target snapshot is fully stored into the second-type storage resource, a target data unit that is still stored in the first-type storage resource and that is included in the target snapshot may be deleted based on the attribute item, and a storage location of the target data unit is modified as the second-type storage resource in related snapshot description information.

### CROSS-REFERENCE TO RELATED APPLICATIONS

This application is a national stage of International Application No. PCT/CN2024/078721, filed on Feb. 27, 2024, which claims priority to Chinese Patent Application No. 202310253795.6, filed with the China National Intellectual Property Administration on Mar. 10, 2023 and entitled “SNAPSHOT STORAGE METHOD AND SYSTEM, DEVICE, AND STORAGE MEDIUM”. Both of the aforementioned applications are incorporated herein by reference in their entireties.

### TECHNICAL FIELD

The present application relates to the field of storage technologies, and in particular, to a snapshot storage method and system, a device, and a storage medium.

### BACKGROUND

With continuous enhancement of awareness of users for cloud data protection, more and more users choose to save, in a form of a snapshot, data generated in their virtual storage devices used in a cloud.

A snapshot refers to a complete copy or an image of data in the virtual storage device of the cloud at a time point, and is an important data disaster redundancy means. When the data in the virtual storage device is lost or abnormal, the data in the virtual storage device may be completely recover to a certain time point by using the snapshot. Important data may be periodically backed up by using the snapshot, to mitigate a risk of data loss caused by a misoperation, an attack, a virus, or the like.

Currently, in a scenario such as a data security audit, there is a strict requirement on integrity and storage duration of some snapshots. Therefore, the snapshots need to be stored in full and for long time, leading to persistently high snapshot storage costs.

### SUMMARY

Various aspects of the present application provide a snapshot storage method and system, a device, and a storage medium, to reduce snapshot storage costs.

An embodiment of the present application provides a snapshot storage method, including:
in response to a full dump request for a target snapshot stored in a first-type storage resource, fully storing the target snapshot into a second-type storage resource;
if it is determined, based on snapshot description information corresponding to the target snapshot, that the target snapshot includes a target data unit of which a storage location is marked as the first-type storage resource, deleting the target data unit from the first-type storage resource; and
marking, in snapshot description information corresponding to a further snapshot including the target data unit and the snapshot description information corresponding to the target snapshot, a storage location corresponding to the target data unit as the second-type storage resource, where
a storage cost of the second-type storage resource is lower than that of the first-type storage resource.

An embodiment of the present application further provides a snapshot storage system, including a management and control node and a storage cluster. The storage cluster is configured to provide a first-type storage resource and a second-type storage resource that have different storage costs. The management and control node is configured to implement the foregoing snapshot storage method, to store a target snapshot by using the first-type storage resource or the second-type storage resource.

An embodiment of the present application further provides an electronic device, including a memory and a processor, where
the memory is configured to store one or more computer instructions; and
the processor is coupled to the memory and configured to execute the one or more computer instructions, to perform the foregoing snapshot storage method.

An embodiment of the present application further provides a computer-readable storage medium storing computer instructions, when the computer instructions are executed by one or more processors, enabling the one or more processors to perform the foregoing snapshot storage method.

In embodiments of the present application, after a snapshot is generated, the snapshot may be stored into a first-type storage resource. On this basis, in response to a full dump request for a target snapshot in the first-type storage resource, the target snapshot may be fully stored into a second-type storage resource, where a storage cost of the second-type storage resource is lower than that of the first-type storage resource. In addition, an attribute item used for identifying a storage location of a single data unit is further added to snapshot description information. After the target snapshot is fully stored into the second-type storage resource, a target data unit that is still stored in the first-type storage resource and that is included in the target snapshot may be deleted based on the attribute item, and a storage location of the target data unit is modified as the second-type storage resource in related snapshot description information. In this way, on the premise that a requirement for full storage of the target snapshot is satisfied, duplicated storage of data units between two types of storage resources can be avoided based on a storage location marked for the data unit, thereby effectively reducing snapshot storage costs.

### BRIEF DESCRIPTION OF THE DRAWINGS

The accompanying drawings described herein are used to provide a further understanding of the present application, and form part of the present application. Exemplary embodiments of the present application and descriptions thereof are used to explain the present application, and do not constitute any inappropriate limitation to the present application. In the accompanying drawings:

FIG. 1 is a schematic flowchart of a snapshot storage method according to an exemplary embodiment of the present application.

FIG. 2 is a logic schematic diagram of a snapshot storage method according to an exemplary embodiment of the present application.

FIG. 3 is a schematic flowchart of a snapshot recovery solution according to an exemplary embodiment of the present application.

FIG. 4 is a schematic diagram of an application scenario of a change of a storage status of a snapshot in a full dump process according to an exemplary embodiment of the present application.

FIG. 5 is a schematic diagram of an application scenario of snapshot description information after full dump according to an exemplary embodiment of the present application.

FIG. 6 is a schematic diagram of an application scenario of a change of a storage status of a snapshot in a snapshot recovery process according to an exemplary embodiment of the present application.

FIG. 7 is a schematic diagram of an application scenario of snapshot description information after snapshot recovery is performed according to an exemplary embodiment of the present application.

FIG. 8 is a schematic diagram of a structure of an electronic device according to another exemplary embodiment of the present application.

### DESCRIPTION OF EMBODIMENTS

To make state the objectives, technical solutions clearer, and advantages of the present application, the technical solutions of the present application will be clearly and completely described below with reference to specific embodiments of the present application and the accompanying drawings. Apparently, the described embodiments are only some embodiments rather than all embodiments of the present application. All other embodiments obtained by a person of ordinary skill in the art based on embodiments of the present application without creative efforts shall fall within the protection scope of the present application.

Currently, costs of snapshot storage remain persistently high. Therefore, in some embodiments of the present application: after a snapshot is generated, the snapshot may be stored into a first-type storage resource. On this basis, in response to a full dump request for a target snapshot in the first-type storage resource, the target snapshot may be fully stored into a second-type storage resource, where a storage cost of the second-type storage resource is lower than that of the first-type storage resource. In addition, an attribute item used for identifying a storage location of a single data unit is further added to snapshot description information. After the target snapshot is fully stored into the second-type storage resource, a target data unit that is still stored in the first-type storage resource and that is included in the target snapshot may be deleted based on the attribute item, and a storage location of the target data unit is modified as the second-type storage resource in related snapshot description information. In this way, on the premise that a requirement for full storage of the target snapshot is satisfied, duplicated storage of data units between two types of storage resources can be avoided based on a storage location marked for the data unit, thereby effectively reducing snapshot storage costs.

The following describes the technical solution provided in each embodiment of the present application in detail with reference to the accompanying drawings.

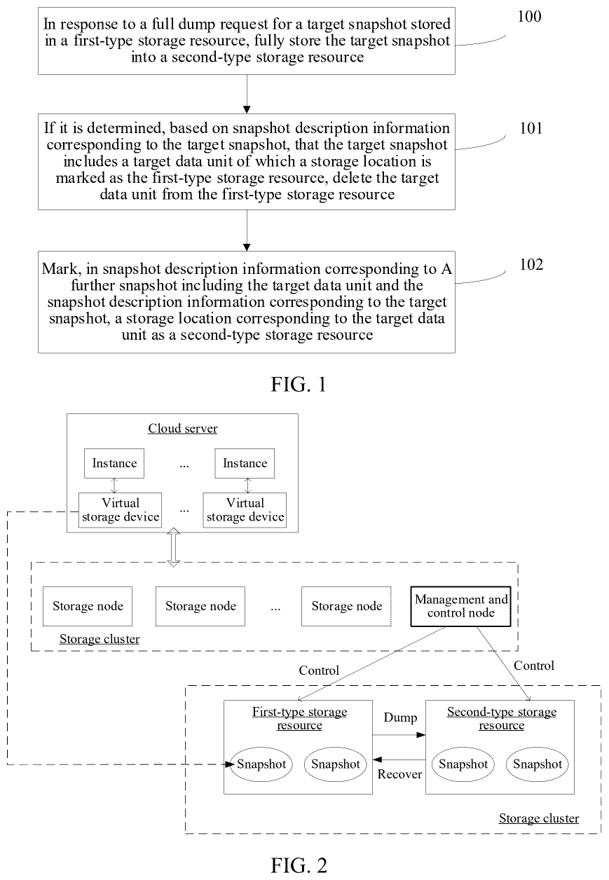

FIG. 1 is a schematic flowchart of a snapshot storage method according to an exemplary embodiment of the present application. With reference to FIG. 1, the method may include the following steps.
Step 100, in response to a full dump request for a target snapshot stored in a first-type storage resource, fully store the target snapshot into a second-type storage resource.
Step 101, if it is determined, based on snapshot description information corresponding to the target snapshot, that the target snapshot includes a target data unit of which a storage location is marked as the first-type storage resource, delete the target data unit from the first-type storage resource.
Step 102, mark, in snapshot description information corresponding to a further snapshot including the target data unit and the snapshot description information corresponding to the target snapshot, a storage location corresponding to the target data unit as the second-type storage resource.

A storage cost of the second-type storage resource is lower than that of the first-type storage resource.

The snapshot storage method provided in this embodiment is applicable to various scenarios in which snapshot storage needs to be performed, including but not limited to scenarios such as data disaster redundancy, cloud disk copy, or cloud disk backup. An application scenario is not limited in this embodiment.

As described in the background, a snapshot refers to a complete copy or an image of data in a virtual storage device of a cloud at a time point, and is an important data disaster redundancy means. The virtual storage device may be a logical storage device, for example, a virtual machine disk, generated by performing storage virtualization on a storage cluster. FIG. 2 is a logic schematic diagram of a snapshot storage method according to an exemplary embodiment of the present application. With reference to FIG. 2, a virtual storage device may run on a cloud server, and is used as a computer disk for reading and writing. A storage virtualization technology is a technology in which a physical storage resource is abstracted into a logical storage resource, to provide higher flexibility and scalability, and to reduce complexity and costs of storage management. Details are not described herein.

In addition, with reference to FIG. 2, in addition to a storage node providing a physical storage resource, the foregoing storage cluster may further include a management and control node. The snapshot storage method in this embodiment may be implemented on the management and control node. In this embodiment, a snapshot may be created separately for a respective virtual storage device provided by the storage cluster, and there may be one or more snapshots created for a single virtual storage device. A plurality of snapshots created for the same virtual storage device may respectively correspond to different time points. The management and control node in the storage cluster may be configured to manage the snapshot corresponding to the respective virtual storage device.

In actual application, to reduce storage space occupation of a respective virtual storage device on the cloud server, the foregoing management and control node usually stores the created snapshot into another storage location outside of the storage cluster providing the virtual storage devices. In some public documents in the industry, another storage location herein is sometimes referred to as a snapshot repository. Certainly, this is merely an example title.

In this embodiment, the snapshot may still be stored into the snapshot repository according to a conventional solution. However, in this embodiment, the storage solution is optimized for some snapshots stored in the snapshot repository, to meet a storage requirement for the snapshot in a scenario, for example, data security auditing. In these scenarios, the snapshot is required to be stored in full and for long time, leading to a continuous increase in snapshot storage costs.

In this embodiment, a resource used for storing the snapshot in a conventional solution is described as a first-type storage resource. On this basis, a second-type storage resource is introduced in this embodiment. A storage cost of the second-type storage resource is lower than that of the first-type storage resource. In an implementation, the first-type storage resource may adopt a standard storage tier resource provided by an object storage cluster, and the second-type storage resource may adopt an archive storage tier resource provided by an object storage cluster. Currently, an object storage cluster (Object Storage Service, OSS) may provide a tiered storage service. A tiered structure of the object storage cluster may include at least a standard storage tier and an archive storage tier. The standard storage tier may provide an object storage service with high persistence, high availability, and high performance, and support frequent data access. The archive storage tier is much cheaper than the standard storage tier, and has a data access speed lower than that of the standard storage tier. Certainly, in this embodiment, another implementation may alternatively be used to implement the first-type storage resource and the second-type storage resource. For example, two independent storage clusters are separately deployed to respectively provide two types of storage resources, and so on. The implementations of the first-type storage resource and the second-type storage resource are not limited in this embodiment, as long as it is ensured that the storage cost of the second-type storage resource is lower than that of the first-type storage resource.

On this basis, with reference to FIG. 1, in step 100, in response to the full dump request for the target snapshot stored in the first-type storage resource, the target snapshot may be fully stored into the second-type storage resource. The full dump request is used for indicating to perform full storage on the target snapshot. The full storage may be understood as that a respective data unit included in the target snapshot is fully stored in storage space corresponding to the target snapshot. In actual application, the virtual storage device may provide a storage service by using a current storage protocol or a storage protocol that may appear in the future, for example, a block storage EBS (Elastic Block Service) protocol. This is not limited in this embodiment. For different storage protocols, specifications of the data unit may be different. For example, for the block storage protocol, the data unit in the snapshot is a data block. It should be understood that a specification of the data unit in the snapshot is consistent with a data access specification supported by the virtual storage device.

In this embodiment, it is proposed that a snapshot that needs to be fully stored may be changed to be stored by using the second-type storage resource, to effectively reduce storage costs of the snapshot.

In this embodiment, it is further proposed that an attribute item of a storage location for a single data unit is added in snapshot description information corresponding to the snapshot. The snapshot description information is used for recording attribute information of the snapshot. The attribute information may include, but is not limited to, an identifier of the snapshot, an identifier, reference relationship information, and a storage location provided in this embodiment of a respective data unit included in the snapshot, and the like. The reference relationship information is used for representing a reference relationship between the respective data unit included in the snapshot and a data unit included in a further snapshot. In actual application, in description information of different snapshots, a same data unit identifier may be used for a same data unit, to reflect a reference relationship between snapshots at a data unit level. An example format of the data unit identifier may be [snapshot number-data unit number-data unit name]. For example, a data unit identifier snap1-1-A may indicate a 1st data unit in a snapshot 1 and is named A. If the data unit is referenced in a snapshot 2, the data unit identifier of the data unit is retained in snapshot description information of the snapshot 2, to represent a reference relationship between the snapshot 2 and the snapshot 1. Certainly, this is merely an example. The data unit identifier in this embodiment may alternatively be represented in another format, and the reference relationship may alternatively be represented in another manner. This is not limited in this embodiment. In addition, in this embodiment, it is proposed that an attribute item of a dump state may be further added to the snapshot description information, to represent the dump state of the snapshot. The dump state may include, but is not limited to, full dump, partial dump, no dump, and the like. The dump state may mainly play a role in a snapshot recovery process mentioned below.

On this basis, with reference to FIG. 1, in step 101, the snapshot description information corresponding to the target snapshot may be queried, and it is determined whether a target data unit of which a storage location is marked as a first-type storage resource exists in the respective data unit included in the target snapshot. If the target data unit exists, the target data unit may be deleted from the first-type storage resource.

In this embodiment, a storage location marked for a data unit in the snapshot description information corresponding to different snapshots may be updated in time based on an actual change of the storage location of the data unit, to accurately record the storage location of the respective data unit in each snapshot. Therefore, if the storage location of the target data unit in the target snapshot is marked as the first-type storage resource, it indicates that the first-type storage resource still stores the target data unit. In this embodiment, the target data unit may be deleted from the first-type storage resource.

More importantly, with reference to FIG. 1, in step 102, the storage location corresponding to the target data unit needs to be marked as the second-type storage resource in the snapshot description information corresponding to a further snapshot including the target data unit and the snapshot description information corresponding to the target snapshot. It should be understood that the target data unit may be included in different snapshots. Therefore, in step 102, after the target data unit is deleted from the first-type storage resource, the snapshot description information respectively corresponding to all snapshots including the target data unit needs to be jointly modified, and the storage location of the target data unit is marked as the second-type storage resource in the snapshot description information.

Preferably, in this embodiment, the snapshot description information may be stored in the first-type storage resource. In a process of performing the snapshot storage method provided in this embodiment, the management and control node may invoke an application programming interface (API) provided by the first-type storage resource to access related snapshot description information. For example, the management and control node may invoke a read interface to perform the foregoing operation of querying the snapshot description information corresponding to the target snapshot, and may invoke a write interface to perform the foregoing operation of marking the storage location corresponding to the target data unit as the second-type storage resource.

In addition, it should be noted that, in this embodiment, after the target snapshot is deleted from the first-type storage resource, the snapshot description information of the target snapshot is not synchronously deleted, but remains to be used as a reference basis in a process of performing full dump on a further snapshot or in a snapshot recovery solution that is mentioned below.

In this way, the target snapshot may be fully moved to the second-type storage resource, and the first-type storage resource no longer needs to store the target snapshot. Apparently, compared with using the first-type storage resource, a storage cost of fully storing the target snapshot by using the second-type storage resource is lower. Moreover, the target data unit already dumped to the second-type storage resource from the first-type storage resource is deleted, so that a storage cost consumed by the target data unit in the first-type storage resource may be further reduced.

According to this, in this embodiment, after a snapshot is generated, the snapshot may be stored into the first-type storage resource. On this basis, in response to a full dump request for a target snapshot in the first-type storage resource, the target snapshot may be fully stored into a second-type storage resource, where a storage cost of the second-type storage resource is lower than that of the first-type storage resource. In addition, an attribute item used for identifying a storage location of a single data unit is further added to snapshot description information. After the target snapshot is fully stored into the second-type storage resource, a target data unit that is still stored in the first-type storage resource and that is included in the target snapshot may be deleted based on the attribute item, and a storage location of the target data unit is modified as the second-type storage resource in related snapshot description information. In this way, on the premise that a requirement for full storage of the target snapshot is satisfied, duplicated storage of data units between two types of storage resources can be avoided based on a storage location marked for the data unit, thereby effectively reducing snapshot storage costs.

In the foregoing or following embodiments, in a process of fully storing the target snapshot into the second-type storage resource, the snapshot description information corresponding to the target snapshot may be queried. If it is determined that the target snapshot includes the target data unit of which a storage location is marked as the first-type storage resource, the target data unit may be copied into target storage space provided by the second-type storage resource for the target snapshot. In actual application, with reference to FIG. 2, the management and control node may invoke a copy interface provided by the second-type storage resource, to copy the target data unit into target storage space that is in the second-type storage resource and that is provided for the target snapshot.

In addition to the target data unit, the target snapshot may further include a dumped data unit of which storage location is marked as the second-type storage resource. For the dumped data unit, a storage location of the dumped data unit in the snapshot description information of the target snapshot may be identified as the second-type storage resource because the dumped data unit is included in a further snapshot, and this further snapshot is already fully dumped into the second-type storage resource.

It should be understood that according to the snapshot storage method provided in this embodiment, the dumped data unit of which the storage location is marked as the second-type storage resource does not exist in the first-type storage resource. Therefore, in a preferred implementation, in the second-type storage resource, the dumped data unit may be copied into the target storage space. It should be understood that in the second-type storage resource, to satisfy a requirement for full storage of the target snapshot, even if the dumped data unit already exists in storage space provided by the second-type storage resource for a further snapshot, the dumped data unit also needs to be further copied into the target storage space provided by the second-type storage resource for the target snapshot. In this way, all data units included in the target snapshot are to be obtained from the target storage space provided by the second-type storage resource for the target snapshot, to implement the full storage of the target snapshot.

Certainly, in addition to the foregoing preferred implementation, in this embodiment, another implementation may alternatively be used to copy the foregoing dumped data unit into the target storage space provided by the second-type storage resource for the target snapshot. For example, the dumped data unit may be first copied from the second-type storage resource into the storage space provided by the first-type storage resource for the target snapshot, and all data units (including the target data unit and the copied back dumped data unit) in the storage space are copied into the target storage space provided by the second-type storage resource for the target snapshot.

In addition, in this embodiment, a snapshot may be stored in the first-type storage resource in an incremental manner. In the incremental manner, a 1st snapshot created for a virtual storage device is a full snapshot, and an empty data unit does not be backed up; and subsequently created snapshots are all incremental snapshots, and only data units that have changed since the last snapshot are backed up. The following describes, by using an example, a solution of storing a snapshot in the incremental manner. Assuming that new data is separately written to a cloud disk of an ECS instance of the cloud server at 10:00 and 11:00, data blocks of the cloud disk are A, B, and C at 9:00. In this case, a 1st snapshot 1 is created, and the data blocks A, B, and C are backed up in the snapshot 1. The snapshot 1 is a full snapshot, and all data on the cloud disk when the snapshot 1 is created is backed up. Data is written to the cloud disk continuously, the data block A is modified as A1, the data block B is modified as B1, and a new data block D is added. A 2nd snapshot 2 is created at 10:00. The changed data blocks A1, B1, and D are only backed up in the snapshot 2, and the snapshot 2 is an incremental snapshot. Snapshot description information of the snapshot 2 records full data blocks A1, B1, C, and D of the cloud disk, where the data block C is from the snapshot 1. Data is written to the cloud disk continuously, the data block C is modified as C1, and a new data block E is added. A 3rd snapshot 3 is created at 11:00. The changed data blocks C1 and E are only backed up in the snapshot 3, and the snapshot 3 is an incremental snapshot. Snapshot description information of the snapshot 3 records full data blocks A1, B1, C1, D, and E of the cloud disk, where the data blocks A1, B1, and D are from the snapshot 2. By analogy, a respective snapshot created for the cloud disk is separately stored into the first-type storage resource.

It may be learned that in the first-type storage resource, for the incremental snapshot, a data unit referenced by the incremental snapshot is not stored in storage space corresponding to the incremental snapshot, but is stored in storage space corresponding to a parent snapshot of the incremental snapshot. On this basis, in this embodiment, when the target data unit is deleted from the first-type storage resource, if the target data unit is referenced by the target snapshot from a parent snapshot of the target snapshot, the target data unit is deleted from storage space provided by the first-type storage resource for the parent snapshot; and if the target data unit is an increment occurring in the target snapshot, the target data unit is deleted from the storage space provided by the first-type storage resource for the target snapshot. In addition, after a deletion operation on the target data unit is completed, the storage space provided by the first-type storage resource for the target snapshot may be released.

Certainly, in this embodiment, the first-type storage resource may alternatively store the snapshot in a full manner or store the snapshot in combination of a full manner and an incremental manner. In these cases, snapshot description information corresponding to a respective snapshot may be queried to determine which snapshots include the target data unit of which a storage location is identified as the first-type storage resource, so as to delete the target data unit from storage space corresponding to the queried snapshot in the first-type storage resource.

In this way, in this embodiment, regardless of storage space corresponding to which snapshot/snapshots in the first-type storage resource the target data unit is/are stored, the target data unit may be completely deleted, to avoid duplicated storage of the target data unit.

In the foregoing or following embodiments, a snapshot may alternatively be obtained from the first-type storage resource according to a conventional solution, to perform data recovery, copy, or other processing on the virtual storage device. Because some of the snapshots are already fully stored into the second-type storage resource, there may be a case in which a specified snapshot needs to be recovered from the second-type storage resource to the first-type storage resource.

For ease of description, in this embodiment, the target snapshot is still used as an example to describe the snapshot recovery solution in detail. It should be understood that the premise herein is that the target snapshot is already fully stored into the second-type storage resource according to the snapshot storage method provided in the foregoing embodiment.

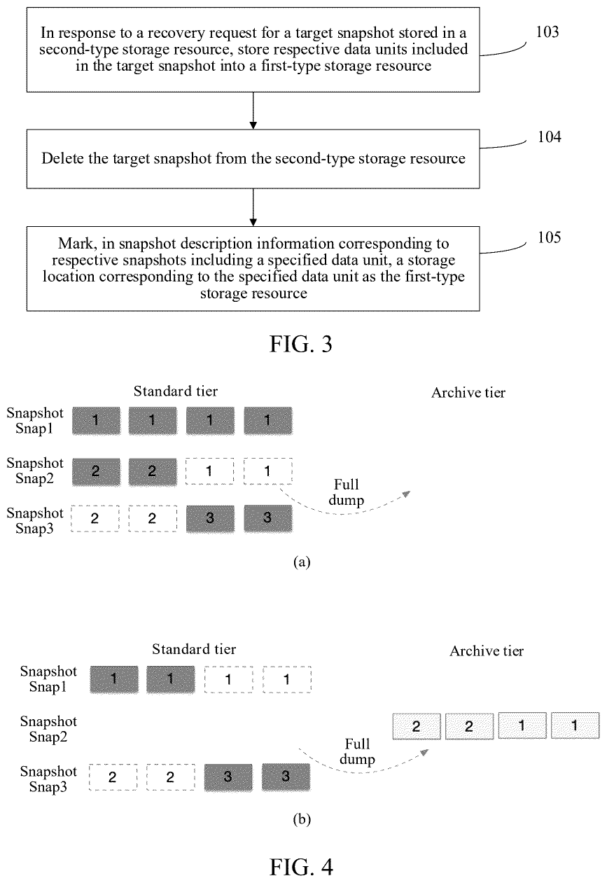

FIG. 3 is a schematic flowchart of a snapshot recovery solution according to an exemplary embodiment of the present application. With reference to FIG. 3, the snapshot recovery solution may include the following steps.
Step 103, in response to a recovery request for a target snapshot stored in a second-type storage resource, store respective data units included in the target snapshot into a first-type storage resource.
Step 104, delete the target snapshot from the second-type storage resource.
Step 105, mark, in snapshot description information corresponding to respective snapshots including a specified data unit, a storage location corresponding to the specified data unit as the first-type storage resource.

The specified data unit is any one of the respective data units included in the target snapshot.

With reference to FIG. 3, in step 103, a user may initiate access to the target snapshot in a case in which copy, recovery, or the like needs to be performed on a virtual storage device. A dump state may be queried in the snapshot description information corresponding to the target snapshot based on the dump state mentioned in the foregoing embodiment. If the dump state is full dump, the recovery request needs to be created for the target snapshot. Certainly, the recovery request may alternatively be created for the target snapshot based on another trigger condition. This is not limited in this embodiment. The recovery request is used for indicating to recover the target snapshot from the second-type storage resource to the first-type storage resource.

There may be two cases herein: a first case is that all data units included in the target snapshot are not duplicated with a further snapshot; a second case is that the target snapshot includes some data units that are duplicated with a further snapshot.

In the first case, the respective data unit included in the target snapshot may be fully copied from the second-type storage resource into storage space provided by the first-type storage resource for the target snapshot. In this case, full recovery of the target snapshot does not cause duplicated storage of a new data unit in the first-type storage resource.

However, in the second case, duplicated storage of a new data unit may be caused in the first-type storage resource. For the second case, a plurality of implementations may be used in step 103 to avoid duplicated storage of the data unit.

In an implementation, it may be determined, based on the snapshot description information corresponding to the target snapshot, that a to-be-recovered data unit of which a storage location is marked as the second-type storage resource in the respective data units included in the target snapshot. The to-be-recovered data unit is copied from the second-type storage resource into the first-type storage resource. If the target snapshot includes a to-be-recovered data unit of which a storage location is marked as the second-type storage resource, it indicates that in the first-type storage resource, the to-be-recovered data unit are not stored in storage space of any snapshot. Therefore, copying the to-be-recovered data unit from the second-type storage resource into the first-type storage resource does not cause duplicated storage of the new data unit in the first-type storage resource.

In addition, in this implementation, in a case that the snapshot is stored in the first-type storage resource in an incremental manner, if it is determined, based on reference relationship information reserved in the snapshot description information corresponding to the target snapshot, that the to-be-recovered data unit is referenced by the target snapshot from a parent snapshot of the target snapshot, the to-be-recovered data unit is stored into storage space provided by the first-type storage resource for the parent snapshot; and if it is determined, based on the reference relationship information, that the to-be-recovered data unit is an increment occurring in the target snapshot, the to-be-recovered data unit is stored into storage space provided by the first-type storage resource for the target snapshot.

In this way, when a process of completing the recovery of the target snapshot, the respective snapshots in the first-type storage resource may still be stored in the incremental manner, and the incremental manner in the first-type storage resource is not destroyed due to the snapshot recovery. Therefore, the snapshot recovery does not lead to an increase in overall storage costs.

Certainly, in this implementation, in a case that the snapshot is stored in the first-type storage resource in the full manner or in combination of the incremental manner and the full manner, because data unit duplication is considered during the snapshot recovery, this does not lead to an increase in the overall storage costs, and it is even possible to gradually optimize a storage manner of the snapshot in the first-type storage resource to the incremental manner through snapshot recovery processes that occur a plurality of times, thereby reducing the overall storage costs.

It can be learned that, in this implementation, the target snapshot is recovered in a partial recovery manner. In the partial recovery manner, a duplicate data unit may be prevented from being stored in the first-type storage resource, to reduce storage costs consumed by the snapshot recovery as much as possible. In addition, a quantity of data units that are copied from the second-type storage resource back to the first-type storage resource is small, the snapshot recovery efficiency may be improved.

In another implementation, the respective data units included in the target snapshot is copied from the second-type storage resource into the first-type storage resource; the duplicated data unit of which a storage location is marked as the first-type storage resource is determined in a respective copied-back data unit based on the snapshot description information corresponding to the target snapshot; and the duplicated data unit is deleted from the respective copied-back data unit.

Specifically, the respective data units included in the target snapshot may be stored into storage space provided by the first-type storage resource for the target snapshot. In addition, after the duplicated data unit is deleted, if it is determined, based on reference relationship information reserved in the snapshot description information corresponding to the target snapshot, that a target remaining data unit in the respective copied-back data unit is referenced by the target snapshot from a parent snapshot of the target snapshot, the target remaining data unit is moved to storage space provided by the first-type storage resource for the parent snapshot.

In this implementation, the target snapshot is recovered in a full recovery manner. After copying of all data units included in the target snapshot is completed, a duplicated data unit may be deleted again from the first-type storage resource. Although compared with the previous implementation, in this implementation, a quantity of data units that are copied back may be larger. By deleting the duplicated data unit, a duplicate data unit may be prevented from being stored in the first-type storage resource, to reduce storage costs consumed by the snapshot recovery as much as possible.

Certainly, the foregoing two implementations merely are examples, and a manner of storing the respective data units included in the target snapshot into the first-type storage resource is not limited in this embodiment.

With reference to FIG. 3, in step 104, the target snapshot may be further deleted in the second-type storage resource. In actual application, the foregoing management and control node may delete the target snapshot by invoking a delete interface provided by the second-type storage resource. Certainly, target storage space provided by the second-type storage resource for the target snapshot may be released.

More importantly, in step 105, for any data unit included in the target snapshot, a corresponding storage location of the data unit in the related snapshot description information may be further modified. Certainly, there may be a data unit of which a storage location is already identified as a first-type storage resource. For such data units, a storage location of such data units identified in the related snapshot description information remains unchanged.

According to this, in this embodiment, an original reference relationship between snapshots may be maintained in the first-type storage resource after the snapshots are recovered, and duplication of a new data unit in the first-type storage resource caused by the snapshot recovery may be avoided. In this way, snapshot storage costs can be reduced, and the snapshot recovery efficiency is improved.

FIG. 4 is a schematic diagram of an application scenario of a change of a storage status of a snapshot in a full dump process according to an exemplary embodiment of the present application. FIG. (a) in FIG. 4 is a schematic diagram of storage statuses in a first-type storage resource and a second-type storage resource before full dump is performed. FIG. (b) in FIG. 4 is a schematic diagram of storage statuses in a first-type storage resource and a second-type storage resource after full dump is performed. The first-type storage resource in FIG. 4 adopts a standard storage tier resource (shown as a standard tier in FIG. 4) provided by an object storage cluster. The second-type storage resource adopts an archive storage tier resource (shown as an archive tier in FIG. 4) provided by an object storage cluster.

With reference to FIG. 4, when the full dump needs to be performed on a snapshot snap2, because the snapshot snap2 is an incremental snapshot, and two data blocks snap1-3-1 and snap1-4-1 included in the snapshot snap2 are referenced from a parent snapshot snap1 of the snapshot snap2, after a snapshot snap3 is fully stored into the archive tier, the data blocks snap1-3-1 and snap1-4-1 located in storage space of the snapshot snap1 that are in the standard tier and data blocks snap2-1-2 and snap2-2-2 located in storage space of the snapshot snap2 that are in the standard tier need to be deleted from the standard tier.

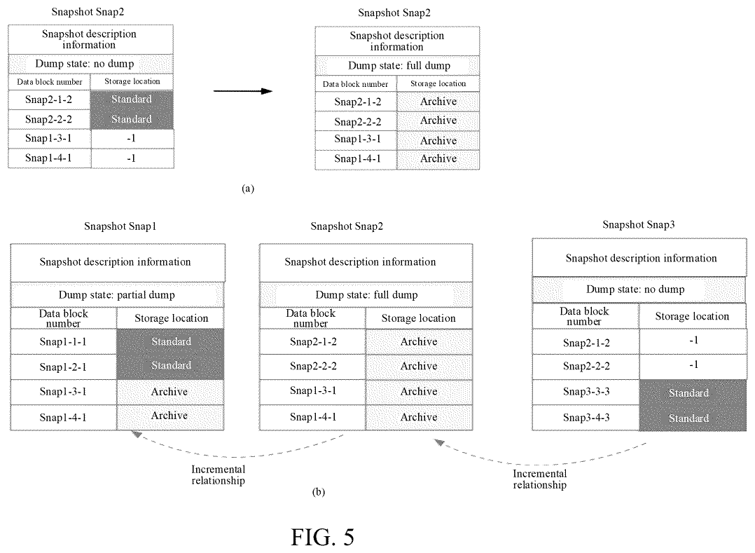

FIG. 5 is a schematic diagram of an application scenario of snapshot description information after full dump according to an exemplary embodiment of the present application. After operations of full dump of a snapshot snap2 and deletion of a related data block in a standard tier are completed, for snapshot description information corresponding to each of snapshots snap1 to snap3, refer to FIG. (b) in FIG. 5. For corresponding snapshot description information before and after the snapshot snap2 is fully dumped, refer to FIG. (a) in FIG. 5. It may be learned with reference to FIG. (a) in FIG. 5 that storage locations corresponding to all data blocks in the snapshot snap2 are identified as “archive tier”. It may be learned with reference to FIG. (b) in FIG. 5 that because the snapshot snap1 is a parent snapshot of the snapshot snap2, storage locations of the data blocks snap1-3-1 and snap1-4-1 in the snapshot description information of the snapshot snap 1 are also identified as “archive tier”. The snapshot snap2 is also a parent snapshot of the snapshot snap3, that is, the snapshot snap3 references data blocks snap2-1-2 and snap2-2-2 in the snapshot snap2. Therefore, storage locations of the data blocks snap2-1-2 and snap2-2-2 in snapshot description information of the snapshot snap3 are also identified as “archive tier”. In actual application, as shown in FIG. 5, the storage locations of the data blocks snap2-1-2 and snap2-2-2 in the snapshot description information of the snapshot snap3 are also identified as “−1”, where “−1” indicates that a storage location of a corresponding data block inherits a storage location of a corresponding data block in a parent snapshot.

In addition, it is assumed that a storage cost of the archive tier is ¼ of a storage cost of the standard tier. In this case:

Standard tier cost of the snapshot Snap2 is 2*data block cost.

Archive tier cost of the snapshot Snap2 is 4*data block cost*¼=1*data block cost.

A total cost before archiving is 8*data block cost.

A total cost after archiving is 4*data block cost+1*data block cost=5*data block cost.

Apparently, the storage cost is reduced.

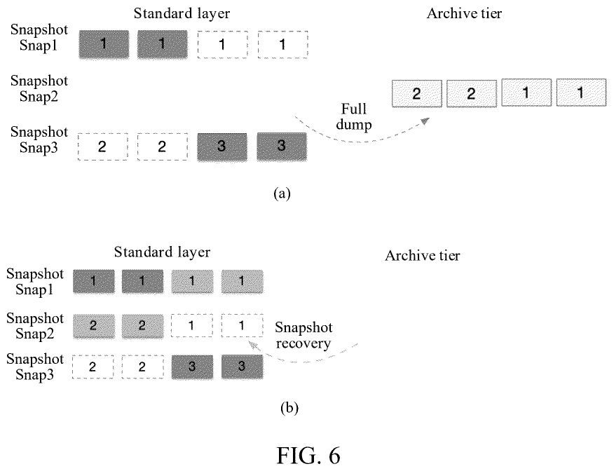

FIG. 6 is a schematic diagram of an application scenario of a change of a storage status of a snapshot in a snapshot recovery process according to an exemplary embodiment of the present application. FIG. (a) in FIG. 6 is a schematic diagram of storage statuses of snapshots at a standard tier and an archive tier before snapshot recovery is performed. FIG. (b) in FIG. 6 is a schematic diagram of storage statuses of snapshots at the standard tier and the archive tier after snapshot recovery is performed.

An example in which a snapshot snap2 is recovered is still used. Before the snapshot recovery is performed, the snapshot snap2 does not exist in the standard tier. After the recovery is performed, based on a reference relationship between the snapshot snap2 and a snapshot snap1, recovered data blocks snap1-3-1 and snap1-4-1 are stored into storage space of the snapshot snap1, and recovered data blocks snap2-1-2 and snap2-2-2 are stored into storage space of the snapshot snap2.

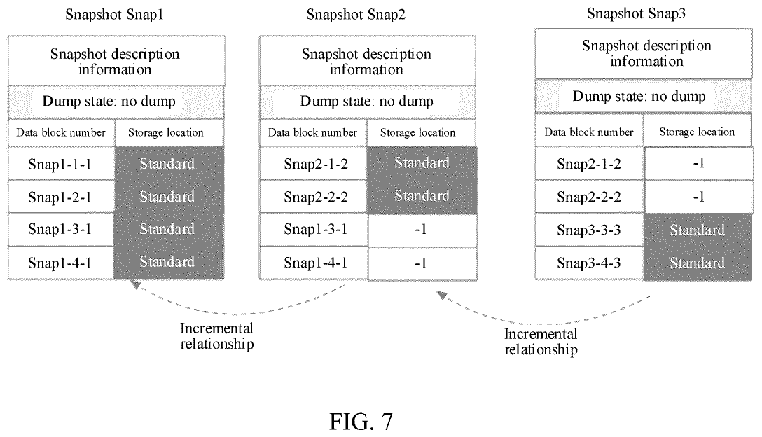

FIG. 7 is a schematic diagram of an application scenario of snapshot description information after snapshot recovery is performed according to an exemplary embodiment of the present application. With reference to FIG. 7, after recovery of a snapshot snap2 is completed, storage locations of all data blocks in a snapshot snap1 are all identified as “standard tier”, storage locations of incremental data blocks in the snapshot snap2 are identified as “standard tier”, and storage locations of data blocks snap1-3-1 and snap1-4-1 that are referenced from the parent snapshot snap1 are identified as “−1”, to indicate that the data blocks inherit corresponding storage locations in the parent snapshot snap1. Similarly, storage locations of data blocks snap2-1-2 and snap2-2-2 in a snapshot snap3 are identified as “−1”, and storage locations of incremental data blocks snap3-3-3 and snap3-4-3 are identified as “standard tier”.

It may be learned that after the recovery of the snapshot snap2 is completed, an original reference relationship is recovered between the snapshots in the standard tier.

It may be learned from FIG. 4 to FIG. 6 that, according to the snapshot storage method provided in this embodiment, full dump and recovery of any snapshot may be implemented, and after the full dump is completed, an overall snapshot storage cost can be reduced while ensuring snapshot integrity. In addition, it can be ensured that after the snapshot recovery, an incremental relationship between original snapshots is maintained, and an overall storage solution does not lead to an increase in the snapshot storage costs. In addition, to ensure that the overall storage costs can be reduced in the storage process, a storage location of a related snapshot data block is added and stored in the snapshot description information of the standard tier, to facilitate searching and positioning of the storage location during the data recovery. The snapshot description information not only includes data block incremental information between snapshots, but also includes information indicating whether a single snapshot is entirely dumped, information about a storage location of an independent data block, and the like, to help quickly position a data block location during the data recovery.

It should be noted that in some procedures described in the foregoing embodiments and accompanying drawings, a plurality of operations occurring in a specific sequence are included. However, it should be clearly understood that the operations may not be performed in the sequence in which the operations occur in this specification or may be performed in parallel. The sequence numbers of the operations, such as 101 and 102, are merely used for distinguishing different operations, and do not indicate any execution sequence. In addition, the procedures may include more or fewer operations, and the operations may be performed in sequence or in parallel.

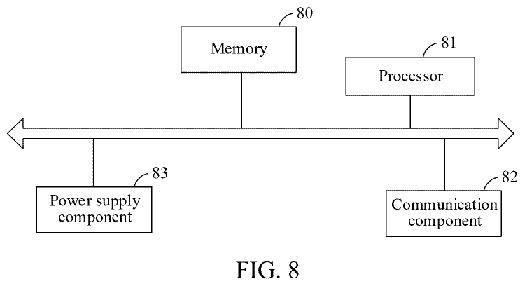

FIG. 8 is a schematic diagram of a structure of an electronic device according to an exemplary embodiment of the present application. As shown in FIG. 8, the electronic device includes a memory 80 and a processor 81.

The processor 81 is coupled to the memory 80, and is configured to execute a computer program in the memory 80 to:
in response to a full dump request for a target snapshot stored in a first-type storage resource, fully store the target snapshot into a second-type storage resource;
if it is determined, based on snapshot description information corresponding to the target snapshot, that the target snapshot includes a target data unit of which a storage location is marked as the first-type storage resource, delete the target data unit from the first-type storage resource; and
mark, in snapshot description information corresponding to a further snapshot including the target data unit and the snapshot description information corresponding to the target snapshot, a storage location corresponding to the target data unit as the second-type storage resource, where
a storage cost of the second-type storage resource is lower than that of the first-type storage resource.

In an embodiment, when fully storing the target snapshot into the second-type storage resource, the processor 81 is specifically configured to:
copy the target data unit into target storage space provided by the second-type storage resource for the target snapshot; and
if it is determined, based on the snapshot description information corresponding to the target snapshot, that the target snapshot includes a dumped data unit of which a storage location is marked as the second-type storage resource, copy the dumped data unit in the second-type storage resource into the target storage space.

In an embodiment, a snapshot is stored in the first-type storage resource in an incremental manner, and when deleting the target data unit from the first-type storage resource, the processor 81 is specifically configured to:
if the target data unit is referenced by the target snapshot from a parent snapshot of the target snapshot, delete the target data unit from storage space provided by the first-type storage resource for the parent snapshot;
if the target data unit is an increment occurring in the target snapshot, delete the target data unit from storage space provided by the first-type storage resource for the target snapshot; and
release the storage space provided by the first-type storage resource for the target snapshot.

In an embodiment, a snapshot is stored in the first-type storage resource in an incremental manner, and the processor 81 may be further configured to:
in response to a recovery request for the target snapshot stored in the second-type storage resource, store respective data units included in the target snapshot into the first-type storage resource;
delete the target snapshot from the second-type storage resource; and
mark, in snapshot description information corresponding to respective snapshots including a specified data unit, a storage location corresponding to the specified data unit as the first-type storage resource, where
the specified data unit is any one of the respective data units included in the target snapshot.

In an embodiment, when storing the respective data units included in the target snapshot into the first-type storage resource, the processor 81 is specifically configured to:
determine, based on the snapshot description information corresponding to the target snapshot, a to-be-recovered data unit of which a storage location is marked as the second-type storage resource in the respective data units included in the target snapshot; and
copy the to-be-recovered data unit from the second-type storage resource into the first-type storage resource.

In an embodiment, when copying the to-be-recovered data unit from the second-type storage resource into the first-type storage resource, the processor 81 is specifically configured to:
if it is determined, based on reference relationship information reserved in the snapshot description information corresponding to the target snapshot, that the to-be-recovered data unit is referenced by the target snapshot from a parent snapshot of the target snapshot, store the to-be-recovered data unit into storage space provided by the first-type storage resource for the parent snapshot; and
if it is determined, based on the reference relationship information, that the to-be-recovered data unit is an increment occurring in the target snapshot, store the to-be-recovered data unit into storage space provided by the first-type storage resource for the target snapshot.

In an embodiment, when storing the respective data units included in the target snapshot into the first-type storage resource, the processor 81 is specifically configured to:
copy the respective data units included in the target snapshot from the second-type storage resource into the first-type storage resource;
determine, based on the snapshot description information corresponding to the target snapshot, a duplicated data unit of which a storage location is marked as the first-type storage resource in a respective copied-back data unit; and
delete the duplicated data unit from the respective copied-back data unit.

In an embodiment, when copying the respective data units included in the target snapshot from the second-type storage resource into the first-type storage resource, the processor 81 is specifically configured to:
store the respective data units included in the target snapshot into storage space provided by the first-type storage resource for the target snapshot; and
after deleting the duplicated data unit, the processor 81 may be further configured to:
if it is determined, based on reference relationship information reserved in the snapshot description information corresponding to the target snapshot, that a target remaining data unit in the respective copied-back data unit is referenced by the target snapshot from a parent snapshot of the target snapshot, move the target remaining data unit to storage space provided by the first-type storage resource for the parent snapshot.

In an embodiment, the first-type storage resource adopts a standard storage tier resource provided by an object storage cluster, and the second-type storage resource adopts an archive storage tier resource provided by an object storage cluster.

In an embodiment, the snapshot description information is stored in the first-type storage resource.

Further, as shown in FIG. 8, the electronic device further includes a communication component 82, a power supply component 83, and other components. Only some components are schematically provided in FIG. 8, and this does not mean that the electronic device only includes the components shown in FIG. 8.

It should be noted that for technical details of the foregoing embodiments of the electronic device, refer to related descriptions in the foregoing method embodiments. For brevity, details are not described herein again, but this should not cause a loss to the protection scope of the present application.

With reference to FIG. 2, an embodiment of the present application further provides a snapshot storage system, including a management and control node and a storage cluster, where the storage cluster is configured to provide a first-type storage resource and a second-type storage resource with different storage costs, and the management and control node is configured to perform the snapshot storage method, to store a target snapshot by using the first-type storage resource or the second-type storage resource.

Accordingly, an embodiment of the present application further provides a computer-readable storage medium storing a computer program. When the computer program is executed, the steps of the foregoing method embodiments are implemented.

The memory in FIG. 8 is configured to store a computer program, and may be configured to store various another data to support operations on a computing platform. Examples of the data include instructions for any application or method operating on the computing platform, contact data, phone book data, messages, pictures, videos, and the like. The memory may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The communication component in FIG. 8 is configured to facilitate communication in a wired or wireless manner between a device in which the communication component is located and another device. The device in which the communication component is located may access a wireless network based on a communication standard, such as a mobile communication network such as Wi-Fi, 2G, 3G, 4G/LTE, 5G, or a combination thereof. In an exemplary embodiment, the communication component receives a broadcast signal or broadcast related information from an external broadcast management system through a broadcast channel. In an exemplary embodiment, the communication component further includes a near field communication (NFC) module, to facilitate short range communication. For example, the NFC module may be implemented based on a radio frequency identification (RFID) technology, an infrared data association (IrDA) technology, an ultra-wideband (UWB) technology, a Bluetooth (BT) technology, and another technology.

The power supply component in FIG. 8 provides power to various components of a device in which the power supply component is located. The power supply component may include a power supply management system, one or more power supplies, and another components associated with generating, managing, and allocating power to the device in which the power supply component is located.

A person skilled in the art should understand that embodiments of the present application may be provided as a method, a system, or a computer program product. Therefore, the present application may use a form of hardware-only embodiments, software-only embodiments, or embodiments combining software and hardware. Moreover, the present application may use a form of a computer program product that is implemented on one or more computer-usable storage medium (including but not limited to a disk memory, a CD-ROM (compact disk-read-only memory), an optical memory, and the like) that include computer-usable program code.

The present application is described with reference to flowcharts and/or block diagrams of the method, the device (system), and the computer program product according to embodiments of the present application. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may be further loaded onto a computer or another programmable data processing device, so that a series of operations and steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

In a typical configuration, a computing device includes one or more processor (CPU), an input/output interface, a network interface, and a memory.

The memory may include a form such as a volatile memory, a random-access memory (RAM) and/or a non-volatile memory such as a read-only memory (ROM) or a flash RAM (flash RAM) in a computer-readable medium. The memory is an example of the computer-readable medium.

The computer-readable medium includes a non-volatile medium and a volatile medium, a removable medium and a non-removable medium, which may implement storage of information by using any method or technology. The information may be a computer-readable instruction, a data structure, a program module, or other data. Examples of computer storage medium include, but are not limited to, a phase change memory (PRAM), a static random-access memory (SRAM), a dynamic random-access memory (DRAM), another type of random-access memory (RAM), a read-only memory (ROM), an electrically erasable programmable read-only memory (EEPROM), a flash memory or another memory technology, a compact disk-read-only memory (CD-ROM), a digital versatile disk (DVD) or another optical storage, a magnetic cassettes, a magnetic disk storage or another magnetic storage devices, or any other non-transmission medium that may be configured to store information accessible by a computing device. According to limitations of this specification, the computer-readable medium does not include transitory computer-readable media (transitory media), such as a modulated data signal and a modulated carrier.

It should be further noted that the terms “comprise”, “include”, or any other variations thereof are intended to cover non-exclusive inclusion, such that a process, method, article, or device that includes a list of elements includes not only those elements, but also another element not expressly listed, or also includes elements inherent to such process, method, commodity, or device. Unless otherwise specified, an element limited by “include a/an . . . ” does not exclude other same elements existing in the process, the method, the article, or the device that includes the element.

It should be noted that user information (including, but not limited to, user equipment information, user personal information, and the like) and data (including, but not limited to, data for analysis, stored data, displayed data, and the like) involved in the present application are both information and data that are authorized by a user or that are sufficiently authorized by parties, and related data needs to be collected, used, and processed by complying with relevant laws, regulations, and standards of relevant countries and regions. In addition, a corresponding operation entry is provided for the user to select to authorize or reject.

The foregoing descriptions are merely embodiments of the present application, but are not intended to limit the present application. For a person skilled in the art, various modifications and variations can be made to the present application. Any modification, equivalent replacement, or improvement made within the spirit and principles of the present application should fall within the protection scope of the present application.

1. A snapshot storage method, comprising:
in response to a full dump request for a target snapshot stored in a first-type storage resource, fully storing the target snapshot into a second-type storage resource;
if it is determined, based on snapshot description information corresponding to the target snapshot, that the target snapshot comprises a target data unit of which a storage location is marked as the first-type storage resource, deleting the target data unit from the first-type storage resource; and
marking, in snapshot description information corresponding to a further snapshot comprising the target data unit and the snapshot description information corresponding to the target snapshot, a storage location corresponding to the target data unit as the second-type storage resource, wherein
a storage cost of the second-type storage resource is lower than that of the first-type storage resource.

2. The method according to claim 1, wherein the fully storing the target snapshot into the second-type storage resource comprises:
copying the target data unit into target storage space provided by the second-type storage resource for the target snapshot; and
if it is determined, based on the snapshot description information corresponding to the target snapshot, that the target snapshot comprises a dumped data unit of which a storage location is marked as the second-type storage resource, copying the dumped data unit in the second-type storage resource into the target storage space.

3. The method according to claim 1, wherein a snapshot is stored in the first-type storage resource in an incremental manner, and the deleting the target data unit from the first-type storage resource comprises:
if the target data unit is referenced by the target snapshot from a parent snapshot of the target snapshot, deleting the target data unit from storage space provided by the first-type storage resource for the parent snapshot;
if the target data unit is an increment occurring in the target snapshot, deleting the target data unit from storage space provided by the first-type storage resource for the target snapshot; and
releasing the storage space provided by the first-type storage resource for the target snapshot.

4. The method according to claim 1, wherein a snapshot is stored in the first-type storage resource in an incremental manner, and the method further comprises:
in response to a recovery request for the target snapshot stored in the second-type storage resource, storing respective data units comprised in the target snapshot into the first-type storage resource;
deleting the target snapshot from the second-type storage resource; and
marking, in snapshot description information corresponding to respective snapshots comprising a specified data unit, a storage location corresponding to the specified data unit as the first-type storage resource, wherein
the specified data unit is any one of the respective data units comprised in the target snapshot.

5. The method according to claim 4, wherein the storing the respective data units comprised in the target snapshot into the first-type storage resource comprises:
determining, based on the snapshot description information corresponding to the target snapshot, a to-be-recovered data unit of which a storage location is marked as the second-type storage resource in the respective data units comprised in the target snapshot; and
copying the to-be-recovered data unit from the second-type storage resource into the first-type storage resource.

6. The method according to claim 5, wherein the copying the to-be-recovered data unit from the second-type storage resource into the first-type storage resource comprises:
if it is determined, based on reference relationship information reserved in the snapshot description information corresponding to the target snapshot, that the to-be-recovered data unit is referenced by the target snapshot from a parent snapshot of the target snapshot, storing the to-be-recovered data unit into storage space provided by the first-type storage resource for the parent snapshot; and
if it is determined, based on the reference relationship information, that the to-be-recovered data unit is an increment occurring in the target snapshot, storing the to-be-recovered data unit into storage space provided by the first-type storage resource for the target snapshot.

7. The method according to claim 4, wherein the storing the respective data units comprised in the target snapshot into the first-type storage resource comprises:
copying the respective data units comprised in the target snapshot from the second-type storage resource into the first-type storage resource;
determining, based on the snapshot description information corresponding to the target snapshot, a duplicated data unit of which a storage location is marked as the first-type storage resource in a respective copied-back data unit; and
deleting the duplicated data unit from the respective copied-back data unit.

8. The method according to claim 7, wherein the copying the respective data units comprised in the target snapshot from the second-type storage resource into the first-type storage resource comprises:
storing the respective data units comprised in the target snapshot into storage space provided by the first-type storage resource for the target snapshot; and
after the deleting the duplicated data unit, the method further comprises:
if it is determined, based on reference relationship information reserved in the snapshot description information corresponding to the target snapshot, that a target remaining data unit in the respective copied-back data unit is referenced by the target snapshot from a parent snapshot of the target snapshot, moving the target remaining data unit to storage space provided by the first-type storage resource for the parent snapshot.

9. The method according to claim 1, wherein the first-type storage resource adopts a standard storage tier resource provided by an object storage cluster, and the second-type storage resource adopts an archive storage tier resource provided by an object storage cluster.

10. A snapshot storage system, comprising a management and control node and a storage cluster, wherein the storage cluster is configured to provide a first-type storage resource and a second-type storage resource that have different storage costs, and the management and control node is configured to implement the snapshot storage method according to claim 1 when executing, to store a target snapshot by using the first-type storage resource or the second-type storage resource.

11. An electronic device, comprising a memory and a processor, wherein
the memory is configured to store one or more computer instructions; and
the processor is coupled to the memory and configured to: in response to a full dump request for a target snapshot stored in a first-type storage resource, fully store the target snapshot into a second-type storage resource;
if it is determined, based on snapshot description information corresponding to the target snapshot, that the target snapshot comprises a target data unit of which a storage location is marked as the first-type storage resource, delete the target data unit from the first-type storage resource; and
mark, in snapshot description information corresponding to a further snapshot comprising the target data unit and the snapshot description information corresponding to the target snapshot, a storage location corresponding to the target data unit as the second-type storage resource, wherein
a storage cost of the second-type storage resource is lower than that of the first-type storage resource.

12. A non-transitory computer-readable storage medium storing computer instructions, when the computer instructions are executed by one or more processors, enabling the one or more processors to:
in response to a full dump request for a target snapshot stored in a first-type storage resource, fully store the target snapshot into a second-type storage resource;
if it is determined, based on snapshot description information corresponding to the target snapshot, that the target snapshot comprises a target data unit of which a storage location is marked as the first-type storage resource, delete the target data unit from the first-type storage resource; and
mark, in snapshot description information corresponding to a further snapshot comprising the target data unit and the snapshot description information corresponding to the target snapshot, a storage location corresponding to the target data unit as the second-type storage resource, wherein
a storage cost of the second-type storage resource is lower than that of the first-type storage resource.

13. The electronic device according to claim 11, wherein the processor is specifically configured to:
copy the target data unit into target storage space provided by the second-type storage resource for the target snapshot; and
if it is determined, based on the snapshot description information corresponding to the target snapshot, that the target snapshot comprises a dumped data unit of which a storage location is marked as the second-type storage resource, copy the dumped data unit in the second-type storage resource into the target storage space.

14. The electronic device according to claim 11, wherein the processor is specifically configured to:
if the target data unit is referenced by the target snapshot from a parent snapshot of the target snapshot, delete the target data unit from storage space provided by the first-type storage resource for the parent snapshot;
if the target data unit is an increment occurring in the target snapshot, delete the target data unit from storage space provided by the first-type storage resource for the target snapshot; and
release the storage space provided by the first-type storage resource for the target snapshot.

15. The electronic device according to claim 11, wherein a snapshot is stored in the first-type storage resource in an incremental manner, and the processor is further configured to:
in response to a recovery request for the target snapshot stored in the second-type storage resource, store respective data units comprised in the target snapshot into the first-type storage resource;
delete the target snapshot from the second-type storage resource; and
mark, in snapshot description information corresponding to respective snapshots comprising a specified data unit, a storage location corresponding to the specified data unit as the first-type storage resource, wherein
the specified data unit is any one of the respective data units comprised in the target snapshot.

16. The electronic device according to claim 15, wherein the processor is specifically configured to:
determine, based on the snapshot description information corresponding to the target snapshot, a to-be-recovered data unit of which a storage location is marked as the second-type storage resource in the respective data units comprised in the target snapshot; and
copy the to-be-recovered data unit from the second-type storage resource into the first-type storage resource.

17. The electronic device according to claim 16, wherein the processor is specifically configured to:
if it is determined, based on reference relationship information reserved in the snapshot description information corresponding to the target snapshot, that the to-be-recovered data unit is referenced by the target snapshot from a parent snapshot of the target snapshot, store the to-be-recovered data unit into storage space provided by the first-type storage resource for the parent snapshot; and
if it is determined, based on the reference relationship information, that the to-be-recovered data unit is an increment occurring in the target snapshot, store the to-be-recovered data unit into storage space provided by the first-type storage resource for the target snapshot.

18. The electronic device according to claim 15, wherein the processor is specifically configured to:
copy the respective data units comprised in the target snapshot from the second-type storage resource into the first-type storage resource;
determine, based on the snapshot description information corresponding to the target snapshot, a duplicated data unit of which a storage location is marked as the first-type storage resource in a respective copied-back data unit; and
delete the duplicated data unit from the respective copied-back data unit.

19. The electronic device according to claim 18, wherein the processor is specifically configured to:
store the respective data units comprised in the target snapshot into storage space provided by the first-type storage resource for the target snapshot; and
if it is determined, based on reference relationship information reserved in the snapshot description information corresponding to the target snapshot, that a target remaining data unit in the respective copied-back data unit is referenced by the target snapshot from a parent snapshot of the target snapshot, move the target remaining data unit to storage space provided by the first-type storage resource for the parent snapshot.

20. The electronic device according to claim 11, wherein the first-type storage resource adopts a standard storage tier resource provided by an object storage cluster, and the second-type storage resource adopts an archive storage tier resource provided by an object storage cluster.
